(19) United States
(12) Patent Application Publication
(10) Pub. No.: US 2026/0154590 A1
(43) Pub. Date: Jun. 4, 2026

(54) METHODS AND SYSTEMS FOR HIGH-FIDELITY QUANTUM MATTER-LINKS

(71) Applicant: Universal Quantum LTD, Brighton (GB)

(72) Inventors: Foni Raphaël Charles LEBRUN-GALLAGHER, Brighton (GB); Mariam AKHTAR, Brighton (GB); Falk BONUS, Brighton (GB); Nicholas Ian JOHNSON, Brighton (GB); Martin SIEGELE-BROWN, Brighton (GB); Samuel James HILE, Hurstplerpoint (GB); Zak David ROMASZKO, Brighton (GB); Winfried HENSINGER, Brighton (GB); Sebastian WEIDT, Brighton (GB)

(21) Appl. No.: 18/952,919

(22) Filed: Nov. 19, 2024

Related U.S. Application Data
(60) Provisional application No. 63/600,869, filed on Nov. 20, 2023.

(51) Int. Cl. G06N 10/40

(52) U.S. Cl. CPC G06N 10/40

(57) ABSTRACT

A trapped-ion quantum computer may include a plurality of quantum computing modules; and a coherent quantum matter-link between adjacent quantum computing modules. The coherent quantum matter-link may be characterized by an infidelity associated with atom loss during transfer between adjacent modules or an infidelity associated with loss of coherence during atom transfer between adjacent modules.

### CROSS-REFERENCE

This application claims the benefit of U.S. Provisional Application No. 63/600,869, filed Nov. 20, 2023, which is incorporated herein in its entirety by reference.

### BACKGROUND

Platforms using trapped atomic ions form an exceptional foundation on which quantum computers (QCs) and quantum simulators can be developed. Encoding qubits in the internal electronic states of trapped ions offers high quantum gate fidelities and long coherence times when compared to other physical implementations. Quantum computing may rely on the quantum mechanical properties of two state quantum mechanical systems to store data. The data may be represented by certain atomic ions, dubbed quantum bits or qubits, which provide the two-state quantum mechanical system. Unlike normal bits, which must be in a 0 or 1, off or on state, qubits can exist in a superposition of quantum states. When combined with entanglement of quantum states, quantum computers are able to gain significant advantage in certain problems over classical computers. One type of quantum computer, a trapped ion quantum computer, and specifically the quantum charged coupled device (QCCD) variant, relies on the transport of charged ions to store information and perform computations. Such platforms using trapped atomic ions form an exceptional foundation on which QCs and quantum simulators can be developed.

### SUMMARY

The quantum computers and quantum matter-links described herein provide particular advantage by conferring high fidelity ion transport between and among quantum computing modules. The advantage conferred by the quantum computers and quantum matter-links described herein is in part due to their application in the construction of ion-trap QC architectures comprising a network of QC modules with high inter-module connection rates that are orders of magnitude faster than qubit decoherence times.

In an aspect disclosed herein is a trapped-ion quantum computer, the trapped-ion quantum computer comprising: a plurality of quantum computing modules; and a coherent quantum matter-link between adjacent quantum computing modules, the coherent quantum matter-link comprising an infidelity per link of less than 5×10⁻⁴, wherein the infidelity per link characterizes a loss of coherence of an ion during transport between adjacent quantum computing modules. In some embodiments, the coherent quantum matter-link comprises an infidelity associated with ion loss during transport of less than 7×10⁻⁸. In some embodiments, the coherent quantum matter-link is characterized at a transfer rate of at least about 2424 s⁻¹ over a total distance of at least about 684 μm. In some embodiments, each module of the plurality of quantum computing modules is fabricated on a substrate, wherein feature electrode structures on a module of the plurality of quantum computing modules extend at least partially to an edge of an inter-module gap, and wherein the substrate of the module recedes at most about 75 um away from the inter-module gap. In some embodiments, a confining potential is configured extend over the inter-module gap and create an electric field interface between the adjacent quantum computing modules. In some embodiments, the feature electrode structures comprise a pair of RF electrodes configured to radially confine the ion. In some embodiments, the pair of RF electrodes are configured to provide a trap depth of at least about 50 meV. In some embodiments, the feature electrode structures comprise a plurality of DC electrode segments configured to axially confine the ion. In some embodiments, the plurality of DC electrode segments is further configured to transport the ion along an axial direction. In some embodiments, the plurality of DC electrode segments is configured to receive a voltage waveform, wherein the voltage waveform is configured to translate a potential well along the axial direction. In some embodiments, a digital to analogue converter is configured to deliver the voltage waveform to a DC electrode of the plurality of DC electrode segments. In some embodiments, the inter-module gap is at least about 10 μm. In some embodiments, the feature electrode structures comprise a pair of RF electrodes situated between a pair of DC electrodes, and wherein the pair of RF electrodes and the pair or DC electrodes are disposed along an axis perpendicular to an ion transport direction. In some embodiments, the feature electrode structures comprise a thickness of about 1 μm. In some embodiments, the substrate comprises silicon. In some embodiments, the feature electrode structures are fabricated by photolithography. In some embodiments, a coherence time of the ion as least about 1,000 times greater than a duration of ion transport. In some embodiments, a piezo actuator configured to align the adjacent quantum computing modules is installed beneath at least one of the adjacent quantum computing modules. In some embodiments, an RF barrier along the quantum-matter link is less than about 0.2 meV. Another aspect of the present disclosure provides a system comprising one or more computer processors and computer memory coupled thereto. The computer memory comprises machine executable code that, upon execution by the one or more computer processors, implements any of the methods above or elsewhere herein.

In an aspect disclosed herein is a trapped-ion quantum computer, the trapped-ion quantum computer comprising: a plurality of quantum computing modules; and a coherent quantum matter-link between adjacent quantum computing modules, the coherent quantum matter-link comprising an infidelity associated with ion loss during transport of less than 7×10⁻⁸. In some embodiments, the coherent quantum matter-link comprises an infidelity per link of less than 5×10⁻⁴, wherein the infidelity per link characterizes a loss of coherence of an ion during transport between adjacent quantum computing modules. In some embodiments, the coherent quantum matter-link is characterized at a transfer rate of at least about 2424 s⁻¹ over a total distance of at least about 684 μm. In some embodiments, each module of the plurality of quantum computing modules is fabricated on a substrate, wherein feature electrode structures on a module of the plurality of quantum computing modules extend at least partially to an edge of an inter-module gap, and wherein the substrate of the module recedes at most about 75 μm away from the inter-module gap. In some embodiments, a confining potential is configured extend over the inter-module gap and create an electric field interface between the adjacent quantum computing modules. In some embodiments, the feature electrode structures comprise a pair of RF electrodes configured to radially confine the ion.

In some embodiments, the pair of RF electrodes are configured to provide a trap depth of at least about 50 meV. In some embodiments, the feature electrode structures comprise a plurality of DC electrode segments configured to axially confine the ion. In some embodiments, the plurality of DC electrode segments is further configured to transport the ion along an axial direction. In some embodiments, the plurality of DC electrode segments is configured to receive a voltage waveform, wherein the voltage waveform is configured to translate a potential well along the axial direction. In some embodiments, a digital to analogue converter is configured to deliver the voltage waveform to a DC electrode of the plurality of DC electrode segments. In some embodiments, the inter-module gap is at least about 10 μm. In some embodiments, the feature electrode structures comprise a pair of RF electrodes situated between a pair of DC electrodes, and wherein the pair of RF electrodes and the pair or DC electrodes are disposed along an axis perpendicular to an ion transport direction. In some embodiments, the feature electrode structures comprise a thickness of about 1 μm. In some embodiments, the substrate comprises silicon. In some embodiments, the feature electrode structures are fabricated by photolithography. In some embodiments, a coherence time of the ion as least about 1,000 times greater than a duration of ion transport. In some embodiments, a piezo actuator configured to align the adjacent quantum computing modules is installed beneath at least one of the adjacent quantum computing modules. In some embodiments, an RF barrier along the quantum-matter link is less than about 0.2 meV. Another aspect of the present disclosure provides a system comprising one or more computer processors and computer memory coupled thereto. The computer memory comprises machine executable code that, upon execution by the one or more computer processors, implements any of the methods above or elsewhere herein.

In an aspect disclosed herein is a trapped-ion quantum computer, the trapped-ion quantum computer comprising: a plurality of quantum computing modules, wherein each module of the plurality of quantum computing modules is fabricated on a substrate, wherein feature electrode structures on a module of the plurality of quantum computing modules extend at least partially to an edge of an inter-module gap, and wherein the substrate of the module recedes at most about 75 μm away from the inter-module gap. In some embodiments, the trapped-ion quantum computer further comprises a coherent quantum matter-link between adjacent quantum computing modules, the coherent quantum matter-link comprising an infidelity associated with ion loss during transport of less than 7×10⁻⁸. In some embodiments, the trapped-ion quantum computer further comprises a coherent quantum matter-link between adjacent quantum computing modules, the coherent quantum matter-link comprising an infidelity per link of less than 5×10⁻⁴, wherein the infidelity per link characterizes a loss of coherence of an ion during transport between adjacent quantum computing modules. In some embodiments, the coherent quantum matter-link is characterized at a transfer rate of at least about 2424 s⁻¹ over a total distance of at least about 684 μm. In some embodiments, a confining potential is configured extend over the inter-module gap and create an electric field interface between the adjacent quantum computing modules. In some embodiments, the feature electrode structures comprise a pair of RF electrodes configured to radially confine the ion. In some embodiments, the pair of RF electrodes are configured to provide a trap depth of at least about 50 meV. In some embodiments, the feature electrode structures comprise a plurality of DC electrode segments configured to axially confine the ion. In some embodiments, the plurality of DC electrode segments is further configured to transport the ion along an axial direction. In some embodiments, the plurality of DC electrode segments is configured to receive a voltage waveform, wherein the voltage waveform is configured to translate a potential well along the axial direction. In some embodiments, a digital to analogue converter is configured to deliver the voltage waveform to a DC electrode of the plurality of DC electrode segments. In some embodiments, the inter-module gap is at least about 10 μm. In some embodiments, the feature electrode structures comprise a pair of RF electrodes situated between a pair of DC electrodes, and wherein the pair of RF electrodes and the pair or DC electrodes are disposed along an axis perpendicular to an ion transport direction. In some embodiments, the feature electrode structures comprise a thickness of about 1 μm. In some embodiments, the substrate comprises silicon. In some embodiments, the feature electrode structures are fabricated by photolithography. In some embodiments, a coherence time of the ion as least about 1,000 times greater than a duration of ion transport. In some embodiments, a piezo actuator configured to align the adjacent quantum computing modules is installed beneath at least one of the adjacent quantum computing modules. In some embodiments, an RF barrier along the quantum-matter link is less than about 0.2 meV. Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1A shows an example ion transport between two quantum computing modules according to one or more embodiments herein.

FIG. 1B shows an example of voltage waveforms applied to segmented electrodes to transport ions along quantum computing modules according to one or more embodiments herein.

FIG. 2 is an illustration of a small section of a modular version of the QCCD quantum computer architecture.

FIG. 3 shows a computer system that is programmed or otherwise configured to implement methods provided herein.

FIG. 4A is a picture of the two microfabricated ion-trap modules used to demonstrate inter-module transport.

FIG. 4B is a schematic of 11 of the DC electrode pairs (DC electrode segments) on the module Alice and 4 of the DC electrode pairs (DC electrode segments) on the module Bob.

FIG. 5A is a plot of Ramsey fringes measured after 0, 2 and 100 links.

FIG. 5B is a plot of the Ramsey fringe contrast as a function of time for 0, 2 and 100 links.

FIG. 6 is a pulse sequence diagram for the Ramsey-type experiment.

FIG. 7 is a diagram of the RF delivery system for the Alice and Bob trap modules.

### DETAILED DESCRIPTION

System scalability may be important for large-scale quantum computers. For quantum computers based on trapped ions, architectures such as the quantum charge-coupled device (QCCD) are used to scale the number of qubits on a single device. However, the number of ions (and therefore qubits) that can be hosted on existing trapped-ion quantum computers may be limited by the practical size of quantum computing modules themselves. Such limitations may be imposed by engineering complexities that arise as the size of quantum computing modules increase. For example, single modules may be limited by fabrication complexity on single wafers (e.g., Si wafers). As such, in some cases herein, the connection of multiple quantum computing modules may provide an area for computation much larger than accessible with a single quantum computing module. The connection of multiple quantum computing modules may provide for more qubits and ultimately a larger, more powerful quantum computer. Further, the coherent quantum matter-links described herein may offer low infidelity due to transport loss, low infidelity due to qubit decoherence, or both.

### Overview

Trapped ion quantum computers provide robust, high-fidelity state preparation and readout, high fidelity universal gate operations, and long qubit coherence times. In a trapped ion quantum computer, ions may be confined in free space using electromagnetic fields. An ion in a trapped ion quantum computer may comprise a single qubit, which may exist in a superposition of two states.

This superposition, when combined with entanglement of other qubit states may facilitate a new paradigm of computing to be exploited. This paradigm may lead to reduced algorithm complexity and ultimately quicker computation. To leverage these qubits to perform computations or quantum logic gates, the ions may be transported among quantum computing modules via coherent quantum matter-links as described herein. A coherent quantum matter-link may provide particular advantage by providing fast ion transfer between modules with low risk of ion loss or qubit decoherence.

Disclosed herein are trapped ion quantum computers comprising coherent quantum matter-links connecting adjacent quantum computing modules. Trapped-ion quantum computing may comprise the transport or manipulation of ions by a plurality of trapped-ion quantum computing modules. Electromagnetic fields may confine and suspend ions in free space, allowing them to be transported, exposed to gating operations, detected, stored, or otherwise used in the execution of quantum computing algorithms.

In some cases, quantum computers as described herein may implement a global microwave radiation field in combination with magnetic field gradients to perform quantum operations. In some cases, the magnetic field gradient may be a static magnetic field gradient. In some cases, the magnetic field gradient may be a switchable magnetic field gradient. In some cases, the global microwave radiation field and magnetic field gradients may be used to perform multi-qubit gate operations. In some cases, a quantum computer as described herein may use a global laser to interact with ions. In some cases, a global laser may be used for sympathetic cooling, ion loading, state preparation, state readout, or any combination thereof. In some cases, there may be a plurality of global lasers. In some cases, a global laser is a laser that is used to perform operations for multiple modules of a quantum computer.

In some cases, a quantum computing module of a quantum computer may have a plurality of zones. In some cases, a zone is configured to perform a particular operation. In some cases, a zone may be a loading zone, a gate zone, a state readout zone, or a memory zone. In some cases, a loading zone may be used to introduce an atom or ion into a quantum computer. In some cases, a loading zone may be used to replace a lost ion. In some cases, an atom may be ionized in a loading zone to provide an ion. In some cases, a gate zone may comprise a region for performing single or multi-qubit gates. In some cases, a gate zone may comprise an entanglement zone. In some cases, a gate zone may be used to perform quantum computations. In some cases, a state readout zone may use a global laser and a photodetector to determine a state of a qubit. In some cases, a state readout zone may be used to determine a state of a qubit or a loss of an ion. In some cases, a memory zone may be used to store an ion that is not actively involved in a quantum computation.

In some cases, a quantum computing module may comprise an X-junction. In some cases, an X-junction may comprise a plurality of zones. In some cases, an X-junction may comprise an intersection of ion transport paths. For example, a first zone of an X-junction may be used to perform a gate operation and a second zone of the X-junction may be used to perform state readout. Accordingly, the quantum computing module may be configured to transport an ion from the first zone to the second zone. In some cases, an X-junction may be a unit cell of a quantum computing module. In some cases, a quantum computing module may have a plurality of X-junctions.

In some cases, a trapped-ion quantum computer may comprise a plurality of quantum computing modules. A module of the plurality of quantum computing modules may be fabricated on a substrate. In some cases, a quantum computing module may comprise feature electrode structures. In some cases, the feature electrode structure may comprise RF electrodes and DC electrodes. In some cases, RF electrodes may be configured to confine an ion in a radial direction. In some cases, DC electrodes may be configured to confine an ion in an axial direction. In some cases, an axial direction is a direction of ion transport. In some cases, a radial direction is a direction perpendicular to a direction of ion transport. The feature electrode structures may extend at least partially to an edge or inter-module gap of the module. In some cases, the substrate may recede away from the edge electrode structures proximal to an inter-module gap. Transport of an ion across an inter-module gap may comprise delivery of the ion from the edge of one quantum computing module to the edge of another quantum computing module.

In some cases, an inter-module gap may be about 10 μm to about 150 μm. In some cases, the inter-module gap may be about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, or more. In some cases, the inter-module gap may be about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, or less.

In some cases, a first quantum computing module may be substantially coplanar with a second quantum computing module. A substantially coplanar alignment herein may comprise an offset of less than about 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm, in one or both of a radial or axial direction. In some cases, a radial direction may be perpendicular to a direction of ion transport. In some cases, an axial direction may be parallel to a direction of ion transport. Additionally, or alternatively, a substantially coplanar alignment herein may comprise a rotational offset of less than about 1 degree, 2 degrees, 3 degrees, 4 degrees, 5 degrees, 6 degrees, 7 degrees, 8 degrees, 9 degrees, 10 degrees, or less in any direction. For example, relative to a first quantum computing module, a second quantum computing module may be rotated about a central axis of the first quantum computing module. In some cases, the central axis may correspond to a direction of ion transport. In another example, relative to the first quantum computing module, the second quantum computing module may be rotated about an axis perpendicular and coplanar with the central axis. In another example, relative to the first quantum computing module, the second quantum computing module may be rotated about an axis perpendicular and not coplanar to the central axis. In some cases, an offset may comprise a combination of rotations described. In some cases, a rotation may be a tilt.

In some cases, a signal of an RF electrode of a first quantum computing module may be aligned with a signal of an RF electrode of a second quantum computing module. The alignment of the RF signals may comprise a substantial alignment of the amplitude or phase of the RF signals. In some cases, the substantial alignment may comprise an amplitude difference between a first RF signal and a second RF signal of less than about 1%, 2%, 3%, 4%, 5%, 6%, 7%, 8%, 9%, 10%, 11%, 12%, 13%, 14%, or 15%. In some cases, the substantial alignment may comprise, in addition or alternatively to the amplitude alignment, a phase offset of the first RF signal and the second RF signal of less than about 1 degree, 2 degrees, 3 degrees, 4 degrees, 5 degrees, 6 degrees, 7 degrees, 8 degrees, 9 degrees, 10 degrees, or less degrees. In some cases, the first RF signal and the second RF signal may comprise a substantially similar frequency. For example, the first RF signal and the second RF signal may comprise a frequency difference of less than about 1 nHz, 1 μHz, 1 mHz, 1 Hz, 1kHz, 1 MHz, or less Hz.

In some cases, a quantum computing module of a quantum computer may comprise a plurality of layers. In some cases, the plurality of layers may be formed upon a substrate. In some cases, the substrate may comprise a material with high resistivity. For example, the substrate may comprise high resistivity silicon. In some cases, a current carrying wire may be embedded in the substrate. In some cases, the current carrying wire may comprise copper. In some cases, a current carrying wire may be configured to generate local magnetic fields. In some cases, a layer disposed along the substrate may comprise a layer of buried wires. In some cases, the wires of the layer of buried wires may be buried in an insulating material. In some cases, a wire of the buried wires may be a conductive material. In some cases, the conductive material may be gold, aluminum, tin, indium, copper, or other metal or conductive alloy. In some cases, the insulating material may comprise silicon dioxide or silicon nitride. In some cases, a metallic layer may be formed along the layer of buried wires. For example, a layer of gold, niobium, or other metallic material may form the metallic layer. In some cases, the metallic layer, the layer of buried wires, or both may form feature electrode structures. In some cases, the layers of a quantum computing module may be electrically connected via vertical interconnect access (VIA) technology. In some cases, the layers of a quantum computing module may be electrically connected to external circuitry for control of feature electrode structures.

In some cases, the external circuitry may comprise a plurality of digital to analog converters. In some cases, external circuitry may comprise an RF electrode source or a DC electrode source. In some cases, an RF source may be amplified and impedance matched to the ion traps using a helical resonator. In some cases, a capacitive divider may be used to measure the RF amplitude and phase applied to each trap on an oscilloscope. In some cases, a capacitive divider may be used to measure the relative phase of the RF signals of adjacent quantum computing modules. In some cases, measuring the relative phase of the RF signals may facilitate alignment of the RF signals to within about 10, 15, 20, 25, 30, 35, 40, or less urad. In some cases, capacitive coupling between adjacent quantum computing modules herein may be less than about 0.1, 0.5, 1, 1.5, 2, 3, 4, 5, or less fF. In some cases, a variable capacitor may be used to match a resonant frequency of RF circuit circuits for adjacent quantum computing modules. In some cases, a quantum computing module may be driven by a direct digital synthesizer (DDS) channel from a frequency synthesizer. In some cases, a DDS output may be amplified.

In some cases, an ion as disclosed herein may comprise a Yb ion. In some cases, the ion may comprise a Yb ion, a Mg ion, a Ca ion, a Sr ion, a Ba ion, or a Be ion. In some cases, the ion may comprise ⁴⁰Ca⁺, ⁴¹Ca⁺, ⁴³Ca⁺, ¹⁷¹Yb⁺, ¹⁷⁴Yb⁺, ⁸⁸Sr⁺, ¹³⁸Ba⁺, ¹³⁷Ba⁺, ¹³³Ba⁺, ⁹Be⁺, ²⁵Mg⁺. In some cases, the ion comprises a two-state quantum mechanical system (qubit).

In some cases, a trapped-ion quantum computer implementing the systems, methods, or devices herein may comprise more than about 10, 10², 10³, 10⁴, 10⁵, 10⁶, 10⁷, or more qubits accessible to perform of a quantum computation.

### Ion Transport Mechanisms

Ion transport may comprise one or both of a shuttling mechanism or a throw-and-catch mechanism. Shuttling or throw-and-catch may be used to transport an ion across an inter-module gap. In some cases, a difference between shuttling and throw-and-catch mechanisms may be described by a difference in the continuity of the pseudopotential between two quantum computing modules. For example, a shuttling mechanism may transport an ion along a continuous pseudopotential path while a throw-and-catch mechanism may transport an ion along a non-continuous pseudopotential path. In some cases, pseudopotential may be generated by a signal passed through an RF electrode used to trap the ion. In some cases, both shuttling and throw-and-catch mechanisms may be used in one trapped-ion quantum computer herein. In some cases, a coherent quantum matter-link may be used to transport ions between quantum computing modules. In some cases, the coherent quantum matter-link may be operable to provide the shuttling mechanism. In some cases, the coherent quantum matter-link may be operable to provide a throw-and-catch mechanism.

In some cases, the shuttling mechanism may comprise transporting an ion across an inter-module gap. Within a quantum computing module, there may be continuous RF electrodes and hence a continuous pseudopotential. As such, the ion may be trapped at every point along a pseudopotential. In inter-module transport, the RF electrodes may be discontinuous between two quantum computing modules. However, a similar pseudopotential generated by the RF electrode of each quantum computing module involved in transport may facilitate shuttling of the ion. The generation of a suitable pseudopotential path along which to shuttle or transport the ion may be dependent on quantum computing module alignment, RF signal frequency alignment, RF signal amplitude alignment, alignment of phase of the voltage on the RF electrodes, or any combination thereof. In some cases, the pseudopotential path may comprise a dip in pseudopotential in the inter-module gap relative to the pseudopotential of the quantum computing modules involved in transport. In some cases, a pseudopotential barrier may be present in the inter-module pseudopotential. The techniques disclosed herein may provide particular utility in facilitating the shuttling mechanism of ion transport. In some cases, the shuttling mechanism may be facilitated by alignment two quantum computing modules as described herein.

In some cases, the shuttling mechanism may comprise transporting the ion through a path of continuous or substantially continuous pseudopotential. In some cases, the pseudopotential may be parameterized, wherein the parameters of the pseudopotential may comprise a potential energy well, a potential barrier height, a potential barrier gradient, or any combination thereof.

In some cases, a potential barrier height along an ion path may be constrained. Generally, the potential barrier height along the ion path should be less than the trap depth. Further, the potential barrier height may be maintained below a threshold value to decrease the introduction of transport infidelities, temperature gain, or both. In some cases, the potential barrier height along a pseudopotential path herein may be less than about 0.1 meV, 0.2 meV, 0.3 meV, 0.4 meV, 0.5 meV, 0.6 me V, 0.7 meV, 0.8 meV, 0.9 meV, 1 meV, 2 meV, 3 meV, 4 meV, 5 meV, 6 meV, 7 meV, 8 meV, 9 meV, or 10 meV.

In some cases, a potential barrier gradient along an ion path may be constrained. In some cases, a large potential barrier gradient along an ion path may introduce transport infidelities. For example, a small barrier with a large gradient may impose greater perturbations on the ion than a larger potential barrier with a less steep gradient. In some cases, the potential barrier gradient may be parameterized to be less than about 0.1 meV per micron, 0.2 meV per micron, 0.3 meV per micron, 0.4 meV per micron, 0.5 meV per micron, 0.6 meV per micron, 0.7 me V per micron, 0.8 meV per micron, 0.9 meV per micron, 1 meV per micron, 2 meV per micron, 3 meV per micron, 4 meV per micron, 5 meV per micron, 6 meV per micron, 7 meV per micron, 8 meV per micron, 9 meV per micron, 10 meV per micron, or less meV per micron.

In some cases, the throw-and-catch mechanism may be used to transport an ion. The throw-and-catch mechanism may be relatively less dependent on the continuity of the pseudopotential between two quantum computing modules than the shuttling mechanism. In throw-and-catch, the ion may be thrown from one module and caught on the other. Substantial alignment between the quantum computing modules, particularly with respect to the RF electrodes, may facilitate the throw-and-catch transport mechanism.

In some cases, throw-and-catch may be desirable as modules may be further apart from each other. However, substantial alignment between the quantum computing modules (e.g., coplanarity, RF electrode alignment) may facilitate successful ion transport. In some cases, RF electrode alignment in the throw-and-catch context may primarily indicate an axial alignment of the ion transport paths of the two quantum computing modules.

In some cases, throw-and-catch may comprise transport without active axial propulsion. For example, a position of the ion transport path may not comprise RF electrodes otherwise used during intra-module transport to shift a pseudopotential minimum during transport. In some cases, throw-and-catch may comprise accelerating an ion with a first subset of electrodes and decelerating the ion with a second subset of electrodes. In some cases, the first subset of electrodes is on a first side of an inter-module gap and the second subset on an opposite side of the inter-module gap. In some cases, DC electrodes may be used to accelerate, decelerate, or both, an ion. In some cases, throw-and-catch may comprise transport without active radial confinement.

A quantum computer as described herein may use a coherent quantum matter-link to transfer ions (or qubits) between adjacent quantum computing modules. In some cases, a qubit is a type of ion that may be used in a trapped ion quantum computer herein. In some cases, ion shuttling may occur via a coherent quantum matter-link. Ion transport between adjacent modules may be realized, for example, at a rate of at least about 2424 s⁻¹ and with an infidelity associated with ion loss during transport below about 7×10⁻⁸. Quantum-matter links may be configured to maintain phase coherence of transported qubits. The coherent quantum matter-link constitutes a practical mechanism for the interconnection of modular trapped ion quantum computing devices (e.g., QCCD devices). In some cases, a coherent quantum matter-link as described herein may facilitate the implementation of modular quantum computers capable of fault-tolerant utility-scale quantum computation. Generally, coherent quantum matter-links and the inter-module transport described herein provides particular advantage by lowering reliance on single-wafer fabrications. Single wafer fabrications may be limited by complexity and difficulty of manufacturability as wafer sizes grow to accommodate a greater number of qubits.

In some cases, the present disclosure provides a trapped-ion quantum computer. The trapped-ion quantum computer may comprise a plurality of quantum computing modules; and a coherent quantum matter-link between adjacent quantum computing modules. In some cases, the coherent quantum matter-link comprises an infidelity associated with ion loss during transport of less than, for example, 7×10⁻⁸. In some cases, the coherent quantum matter-link may be configured to maintain coherence of a qubit during transport.

In some cases, the coherent quantum matter-link is characterized by a transfer rate of about, for example, 2424 s⁻¹ over a total distance of about 50 μm, 100 μm, 150 μm, 200 μm, 250 μm, 300 μm, 350 μm, 400 μm, 450 μm, 500 μm, 550 μm, 600 μm, 650 μm, or 700 μm. In some cases, the coherent quantum matter-link further comprises a coherence infidelity per link of less than 5×10⁻⁴, wherein the fidelity per link characterizes a loss of coherence of an ion during transport between adjacent modules. In some cases, a loss of coherence may comprise a loss of information. In some cases, each module of the plurality of quantum computing modules is fabricated on a substrate. In some cases, feature electrode structures on a module of the plurality of quantum computing modules extend at least partially to an edge of an inter-module gap. For example, the substrate of the module may recede about 75 μm away from the inter-module gap. In some cases, a confining potential is configured to extend over the inter-module gap and create an electric field interface between at least two modules.

In some cases, a coherent quantum matter-link may be characterized by a transfer rate of about 500 s⁻¹, 1,000 s⁻¹, 1,500 s⁻¹, 2,000 s⁻¹, 2,500 s⁻¹, 3000 s⁻¹, or greater over a total distance of about 50 μm, 100 μm, 150 μm, 200 μm, 250 μm, 300 μm, 350 μm, 400 μm, 450 μm, 500 μm, 550 μm, 600 μm, 650 μm, or 700 μm. In some cases, a coherence infidelity per link herein may be less than about 10⁻⁵, 10⁻⁴, 10⁻³, 10⁻², or 10⁻¹. In some cases, an infidelity associated with ion loss during transport herein may be less than about 10⁻⁸, 10⁻⁷, 10⁻⁶, 10⁻⁵, 10⁻⁴, 10⁻³, or 10⁻².

In some cases, a substrate of a quantum computing module may recede away from the inter-module gap by about 10 μm to about 125 μm. In some cases, a substrate of a quantum computing module may recede away from the inter-module gap by about 10 μm to about 25 μm, about 10 μm to about 50 μm, about 10 μm to about 75 μm, about 10 μm to about 100 μm, about 10 μm to about 125 μm, about 25 μm to about 50 μm, about 25 μm to about 75 μm, about 25 μm to about 100 μm, about 25 μm to about 125 μm, about 50 μm to about 75 μm, about 50 μm to about 100 μm, about 50 μm to about 125 μm, about 75 μm to about 100 μm, about 75 μm to about 125 μm, or about 100 μm to about 125 μm. In some cases, a substrate of a quantum computing module may recede away from the inter-module gap by about 10 μm, about 25 μm, about 50 μm, about 75 μm, about 100 μm, or about 125 μm. In some cases, the recession of the substrate may alternatively be described by feature electrode structures extending over an inter-module gap.

The trapped ion quantum computers, trapped ion quantum computing modules, and the methods of operation of the same herein may facilitate computations with greater than about 10¹, 10², 10³, 10⁴, 10⁵, 10⁶, 10⁷, or more qubits. In some cases, the anticipated applications of quantum computers may use orders of magnitude more qubits than accessible via single module quantum computers. For example, simulations of FeMoco (a molecule, FeMo Cofactor, the primary cofactor of nitrogenase which catalyzes nitrogen fixation) may provide better understanding of nitrogen fixation, presumably leading to more efficient mechanisms for producing ammonia from N₂. However, such simulations are estimated to use on the order of 10⁶ qubits. In some cases, the quantum computers and modules described herein may not rely on a single linear ion crystal as a qubit register as with other, non-modular quantum computers. Single linear ion crystals may implement multi-qubit operations via Coulomb interactions within the crystal. Reliance on such a scheme may limit the scalability of systems as limitations of the motional mode density frustrate attempts at using larger single linear ion crystals. As such quantum computations herein may be performed on platforms providing multiple qubit registers via arrays of segmented electrodes, interconnected via coherent quantum matter-links. Such arrays may provide locations or zones within a single module. In some cases, the locations or zones may be allocated specific functions. In some cases, a specific function may be quantum information processing, memory, loading, or state read-out. Generally, RF electrodes may be configured to provide a shared radiofrequency (RF) pseudopotential between electrodes. In some cases, this may confer radial confinement to ions. In some cases, axial confinement may be provided by quasistatic potentials applied to remaining segmented electrodes (e.g., DC electrodes). Such confinement may provide interfacing between small qubit registers via ion transport. In some cases, platforms and modules herein may be amenable to laser-free gating schemes.

In some cases, a coherent quantum matter-link herein may be used to transport qubits between quantum computing modules. In some cases, the transport between modules may be performed at a rate sufficient to execute qubit transport in a time lesser than a duration of qubit coherence. For example, qubit coherence time may be on the order of 500 ms and a duration of ion transport herein may be three orders of magnitude or less than the coherence time for the qubit. In some cases, a transfer rate of a coherent quantum matter-link herein may be about 1500 s⁻¹, 2000s- 1 , 2500 s⁻¹, 3000 s⁻¹, 3500 s⁻¹ or greater. In some cases, ion transport may be about 300 μs to about 600 μs, 300 μs to about 500 μs, 300 μs to about 400 μs, 400 μs to about 600 μs, or 500 μs to about 600 μs.

In some cases, a coherence time of an ion or qubit herein may be from about 10 ms to about 300,000 ms. In some cases, a coherence time of an ion or qubit herein may be about 10 ms to about 5,000 ms. In some cases, a coherence time of an ion or qubit herein may be about 10 ms to about 50 ms, about 10 ms to about 100 ms, about 10 ms to about 500 ms, about 10 ms to about 1,000 ms, about 10 ms to about 1,500 ms, about 10 ms to about 2,000 ms, about 10 ms to about 2,500 ms, about 10 ms to about 3,000 ms, about 10 ms to about 3,500 ms, about 10 ms to about 4,000 ms, about 10 ms to about 5,000 ms, about 50 ms to about 100 ms, about 50 ms to about 500 ms, about 50 ms to about 1,000 ms, about 50 ms to about 1,500 ms, about 50 ms to about 2,000 ms, about 50 ms to about 2,500 ms, about 50 ms to about 3,000 ms, about 50 ms to about 3,500 ms, about 50 ms to about 4,000 ms, about 50 ms to about 5,000 ms, about 100 ms to about 500 ms, about 100 ms to about 1,000 ms, about 100 ms to about 1,500 ms, about 100 ms to about 2,000 ms, about 100 ms to about 2,500 ms, about 100 ms to about 3,000 ms, about 100 ms to about 3,500 ms, about 100 ms to about 4,000 ms, about 100 ms to about 5,000 ms, about 500 ms to about 1,000 ms, about 500 ms to about 1,500 ms, about 500 ms to about 2,000 ms, about 500 ms to about 2,500 ms, about 500 ms to about 3,000 ms, about 500 ms to about 3,500 ms, about 500 ms to about 4,000 ms, about 500 ms to about 5,000 ms, about 1,000 ms to about 1,500 ms, about 1,000 ms to about 2,000 ms, about 1,000 ms to about 2,500 ms, about 1,000 ms to about 3,000 ms, about 1,000 ms to about 3,500 ms, about 1,000 ms to about 4,000 ms, about 1,000 ms to about 5,000 ms, about 1,500 ms to about 2,000 ms, about 1,500 ms to about 2,500 ms, about 1,500 ms to about 3,000 ms, about 1,500 ms to about 3,500 ms, about 1,500 ms to about 4,000 ms, about 1,500 ms to about 5,000 ms, about 2,000 ms to about 2,500 ms, about 2,000 ms to about 3,000 ms, about 2,000 ms to about 3,500 ms, about 2,000 ms to about 4,000 ms, about 2,000 ms to about 5,000 ms, about 2,500 ms to about 3,000 ms, about 2,500 ms to about 3,500 ms, about 2,500 ms to about 4,000 ms, about 2,500 ms to about 5,000 ms, about 3,000 ms to about 3,500 ms, about 3,000 ms to about 4,000 ms, about 3,000 ms to about 5,000 ms, about 3,500 ms to about 4,000 ms, about 3,500 ms to about 5,000 ms, or about 4,000 ms to about 5,000 ms.

### Illustrative Quantum Computing Modules

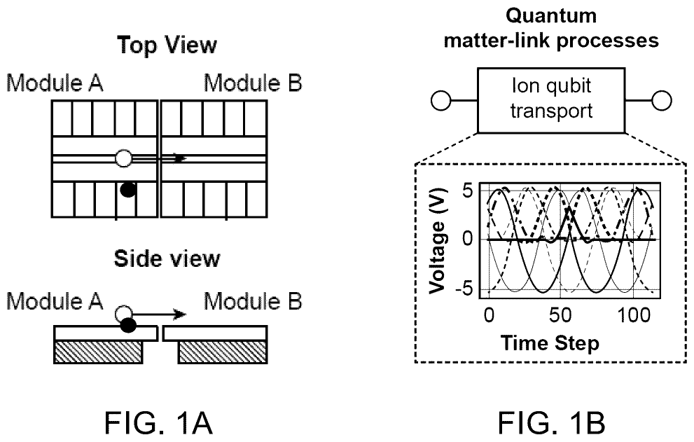

FIG. 1A shows a connection between two quantum computing modules (Module A and Module B, analogous to “Alice” and “Bob” elsewhere herein) via a coherent quantum matter-link. As shown in FIG. 1A, the linked modules may be used for ion transport. In the illustration, surface-electrode ion-trap modules are depicted with an electrode structure that spans to the module's edge. In some cases, the electrodes on the edge of each module are aligned with respect to its neighbor. This may facilitate ion transport via translating potentials from one module, across the inter-module gap, to the next. In some cases, the coherent quantum matter-link may provide an electric field interface between modules. As described herein, transport may be provided by DC voltage waveforms applied to DC electrodes that may control the ion motion such that the ion is physically transported between the modules along a continuous or semi-continuous pseudopotential between modules. Shown in FIG. 1B are illustrative voltage shuttling waveforms that may be used to shuttle ions. In FIG. 1B, the various curves illustrate the DC voltage waveforms of a plurality of electrodes forming an array of segmented electrodes. FIG. 1A depicts a module used for surface trapping ions, but other geometries of surface electrode features may be applicable. In some cases, transporting ions between two quantum computing modules may not require quantum gates. Further, in some cases, for information transfer in a quantum computer using a coherent quantum matter-link, an ion may be transferred with a high quantum-state fidelity (coherence). In some cases, magnetic field shielding or active magnetic field stabilization may further improve quantum-state fidelity in coherent quantum matter-links.

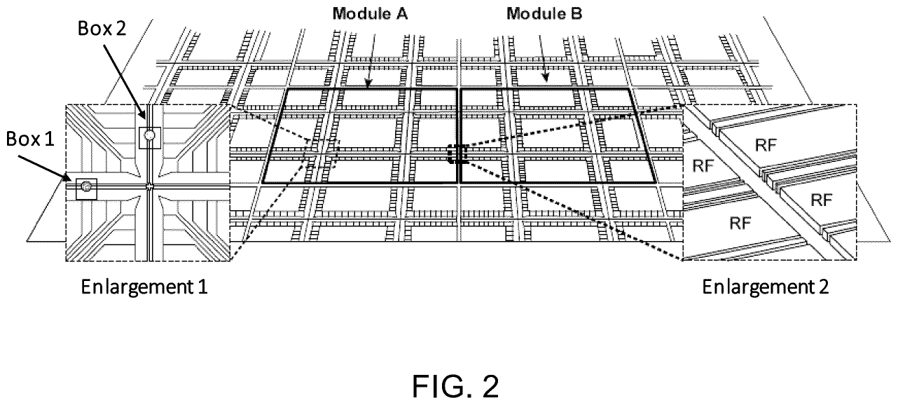

FIG. 2 shows a small section of a modular version of an illustrative trapped ion quantum computer as described herein. FIG. 2 shows previously described Module A and Module B among a plurality of additional quantum computing modules. In the depicted example, each module comprises 4 X-junctions and is structured such that the modules tessellate with neighboring modules. Generally, an X-junction may indicate the intersection of possible ion transport paths. Such intersections may facilitate transporting ions during quantum computation, for example from a memory zone to a state readout zone. In some cases, a single module may have a plurality of X-junctions. In some cases, particular areas of an X-junction are associated with particular functions. For instance, as shown in enlargement 1, an ion may be located in a gate zone for quantum logic operations (box 1) while another qubit may be stored in, or moved to, a memory zone (box 2). Additionally, enlargement 2 depicts the gap separating the modules. As shown, distinct RF electrode pairs extend out to the edge of the modules to create a radially confining potential such that ions can be transported to the neighboring module. Generally, FIG. 2 illustrates how coherent quantum matter-links between modules may facilitate the scaling of trapped-ion quantum computers. Quantum matter-links (and the inter-module transport described herein) provide for the distribution of quantum information between zones within a single module and between modules (e.g., intra and inter-module ion transport). Using coherent quantum matter-links and quantum computing modules, a network of tessellated quantum computing modules may be realized with arbitrary scalability.

As described herein, coherent quantum matter-links provide a practical approach to interfacing modules of a modular quantum computing system. The trapped ion quantum computers, trapped ion quantum computing modules, and methods of using the same herein are operable to realize fast, deterministic, high-fidelity ion-transport using high-fidelity coherent quantum matter-links among quantum computing modules. In some cases, these trapped ion quantum computers, trapped ion quantum computing modules, and methods of using the same may provide particular utility for QCCD architectures. For example, a coherent quantum matter-link described herein may provide ion transport at least about three orders of magnitude faster than measured qubit coherence time. Further, the modules described herein may be accessible via common fabrication techniques while providing low degrees of motional excitation to ions transported among modules. Such transports may improve the fidelity of multi-qubit operations on multi-module trapped ion quantum computers.

### Quantum Computers

The quantum computing modules and coherent quantum matter-links as described herein may be used in a trapped-ion quantum computer. In some cases, a trapped-ion quantum computer may comprise a plurality of quantum computing modules and a coherent quantum matter-link between adjacent quantum computing modules.

In some cases, a coherent quantum matter-link comprises an infidelity per link of less than 5×10⁻⁴, wherein the infidelity per link characterizes a loss of coherence of an ion during transport between adjacent quantum computing modules. In some cases, the infidelity characterized by a loss of coherence may be referred to as a coherent infidelity. In some cases, coherent quantum matter-link comprises an infidelity associated with ion loss during transport of less than 7×10⁻⁸. In some cases, the infidelity characterized by ion loss during transport may be referred to as a transport infidelity. In some cases, the coherent quantum matter link comprises a coherent infidelity of less than about 5×10⁻⁴ and a transport infidelity of less than about 7×10⁻⁸. In some cases, a transport infidelity, a coherent infidelity, or both may be characterized at a transfer rate of at least about 2424 s⁻¹ over a total distance of at least about 684 μm.

In some cases, a module of the plurality of quantum computing modules is fabricated on a substrate. In some cases, feature electrode structures may be formed on a substrate. In some cases, feature electrode structures on a quantum computing module extend at least partially to an edge of an inter-module gap. In some cases, a substrate may recede at most about 75 μm away from the inter-module gap (e.g., as shown in FIG. 1A).

In some cases, the feature electrodes structures may be configured to provide a confining potential extending over an inter-module gap between adjacent quantum computing modules. In some cases, feature electrode structures may form a linear Paul trap. In some cases, the confining potential may create an electric field interface between adjacent quantum computing modules. In some cases, the feature electrode structures may comprise a pair of RF electrodes configured to radially confine the ion. In some cases, radial confinement may comprise confinement in a direction perpendicular to a direction of ion transport. In some cases, the pair of RF electrodes may be configured to provide a trap depth of at least about 50 meV, 75 meV, 100 meV, 125 meV, 150 meV, 175 meV, 200 meV, or more.

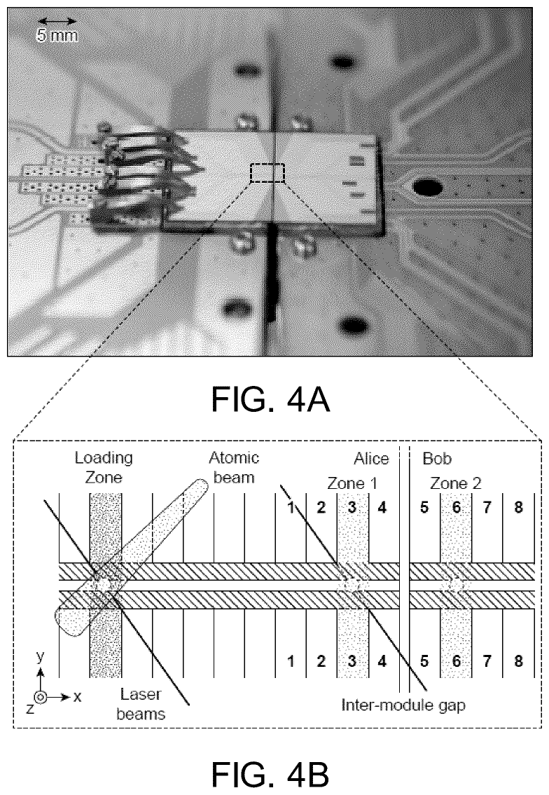

In some cases, the feature electrode structures of a quantum computing module may comprise a plurality of DC electrode segments configured to axially confine the ion. In some cases, axial confinement may comprise confinement in a direction parallel to ion transport. In some cases, DC electrode segments may be as shown in FIG. 4B (e.g., segments 1-8). In some cases, the plurality of DC electrode segments may be further configured to transport the ion along an axial direction. In some cases, the plurality of DC electrode segments may be configured to receive a voltage waveform. In some cases, the voltage waveform is configured to translate a potential well along the axial direction. In some cases, a digital to analogue converter is configured to deliver the voltage waveform to a DC electrode of the plurality of DC electrode segments.

In some cases, the feature electrode structures of a quantum computing module may comprise a pair of RF electrodes situated between a pair of DC electrodes as shown in FIG. 4B (RF electrodes shown by parallel dashed boxes along x-axis). In some cases, the pair of RF electrodes and the pair of DC electrodes are disposed along an axis perpendicular to an ion transport direction. In some cases, surface electrode structures may comprise a plurality of DC electrode segments disposed along an axis parallel to a direction of ion transport. In some cases, the surface electrode structures may comprise two or more rows of DC electrode segments disposed along axes parallel to a direction of ion transport.

In some cases, feature electrode structures may comprise a thickness of about 1 μm. For example, a DC electrode, RF electrode, or both may comprise a thickness of 1 μm. In some cases, thickness may be measured along the z-axis as shown in FIG. 4B. In some cases, a DC electrode, RF electrode, or both may comprise a thickness of about 0.1 μm, 0.2 μm, 0.3 μm, 0.4 μm, 0.5 μm, 0.6 μm, 0.7 μm, 0.8 μm, 0.9 μm, 1 μm, 2 μm, 3 μm, 4 μm, 5 μm, 6 μm, 7 μm, 8 μm, 9 μm, 10 μm, or more. In some cases, a width of an RF electrode, a DC electrode, or both may be about 25 μm to about 300 μm. In some cases, a width of an RF electrode, a DC electrode, or both may be about 25 μm to about 50 μm, about 25 μm to about 75 μm, about 25 μm to about 100 μm, about 25 μm to about 125 μm, about 25 μm to about 150 μm, about 25 μm to about 175 μm, about 25 μm to about 200 μm, about 25 μm to about 225 μm, about 25 μm to about 250 μm, about 25 μm to about 275 μm, about 25 μm to about 300 μm, about 50 μm to about 75 μm, about 50 μm to about 100 μm, about 50 μm to about 125 μm, about 50 μm to about 150 μm, about 50 μm to about 175 μm, about 50 μm to about 200 μm, about 50 μm to about 225 μm, about 50 μm to about 250 μm, about 50 μm to about 275 μm, about 50 μm to about 300 μm, about 75 μm to about 100 μm, about 75 μm to about 125 μm, about 75 μm to about 150 μm, about 75 μm to about 175 μm, about 75 μm to about 200 μm, about 75 μm to about 225 μm, about 75 μm to about 250 μm, about 75 μm to about 275 μm, about 75 μm to about 300 μm, about 100 μm to about 125 μm, about 100 μm to about 150 μm, about 100 μm to about 175 μm, about 100 μm to about 200 μm, about 100 μm to about 225 μm, about 100 μm to about 250 μm, about 100 μm to about 275 μm, about 100 μm to about 300 μm, about 125 μm to about 150 μm, about 125 μm to about 175 μm, about 125 μm to about 200 μm, about 125 μm to about 225 μm, about 125 μm to about 250 μm, about 125 μm to about 275 μm, about 125 μm to about 300 μm, about 150 μm to about 175 μm, about 150 μm to about 200 μm, about 150 μm to about 225 μm, about 150 μm to about 250 μm, about 150 μm to about 275 μm, about 150 μm to about 300 μm, about 175 μm to about 200 μm, about 175 μm to about 225 μm, about 175 μm to about 250 μm, about 175 μm to about 275 μm, about 175 μm to about 300 μm, about 200 μm to about 225 μm, about 200 μm to about 250 μm, about 200 μm to about 275 μm, about 200 μm to about 300 μm, about 225 μm to about 250 μm, about 225 μm to about 275 μm, about 225 μm to about 300 μm, about 250 μm to about 275 μm, about 250 μm to about 300 μm, or about 275 μm to about 300 μm. In some cases, a width of an RF electrode, a DC electrode, or both may be about 25 μm, about 50 μm, about 75 μm, about 100 μm, about 125 μm, about 150 μm, about 175 μm, about 200 μm, about 225 μm, about 250 μm, about 275 μm, or about 300 μm. In some cases, a width of an RF electrode, a DC electrode, or both may be at least about 25 μm, about 50 μm, about 75 μm, about 100 μm, about 125 μm, about 150 μm, about 175 μm, about 200 μm, about 225 μm, about 250 μm, about 275 μm, about 300 μm, or more.

In some cases, a separation between two electrodes of surface electrode features may be about 1 μm to about 10 μm. In some cases, a separation between two electrodes of surface electrode features may be about 1 μm to about 2 μm, about 1 μm to about 3 μm, about 1 μm to about 4 μm, about 1 μm to about 5 μm, about 1 μm to about 6 μm, about 1 μm to about 7 μm, about 1 μm to about 8 μm, about 1 μm to about 9 μm, about 1 μm to about 10 μm, about 2 μm to about 3 μm, about 2 μm to about 4 μm, about 2 μm to about 5 μm, about 2 μm to about 6 μm, about 2 μm to about 7 μm, about 2 μm to about 8 μm, about 2 μm to about 9 μm, about 2 μm to about 10 μm, about 3 μm to about 4 μm, about 3 μm to about 5 μm, about 3 μm to about 6 μm, about 3 μm to about 7 μm, about 3 μm to about 8 μm, about 3 μm to about 9 μm, about 3 μm to about 10 μm, about 4 μm to about 5 μm, about 4 μm to about 6 μm, about 4 μm to about 7 μm, about 4 μm to about 8 μm, about 4 μm to about 9 μm, about 4 μm to about 10 μm, about 5 μm to about 6 μm, about 5 μm to about 7 μm, about 5 μm to about 8 μm, about 5 μm to about 9 μm, about 5 μm to about 10 μm, about 6 μm to about 7 μm, about 6 μm to about 8 μm, about 6 μm to about 9 μm, about 6 μm to about 10 μm, about 7 μm to about 8 μm, about 7 μm to about 9 μm, about 7 μm to about 10 μm, about 8 μm to about 9 μm, about 8 μm to about 10 μm, or about 9 μm to about 10 μm. In some cases, a separation between two electrodes of surface electrode features may be about 1 μm, about 2 μm, about 3 μm, about 4 μm, about 5 μm, about 6 μm, about 7 μm, about 8 μm, about 9 μm, or about 10 μm. In some cases, a separation between two electrodes of surface electrode features may be at least about 1 μm, about 2 μm, about 3 μm, about 4 μm, about 5 μm, about 6 μm, about 7 μm, about 8 μm, or about 9 μm. In some cases, a gap between adjacent quantum computing modules (an inter-module gap) may be at least about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, or more.

In some cases, a substrate of a quantum computing module may comprise silicon, glass, SiN, GaN, GaAs, or other III-V or II-VII semiconductor compounds. In some cases, the feature electrode structures are fabricated by photolithography.

In some cases, a coherence time of an ion as least about 1,000 or 100 times greater than a duration of ion transport. In some cases, a coherence time of an ion may be about 100 to about 1,000 times greater than a duration of ion transport.

In some cases, a piezo actuator may be configured to align adjacent quantum computing modules. In some cases, the piezo actuator may be installed beneath each of the adjacent quantum computing modules. In some cases, the piezo actuator may be installed beneath one of the adjacent quantum computing modules.

In some cases, an RF barrier along the coherent quantum matter-link may be less than 0.1 meV, 0.2 meV, 0.3 meV, 0.4 meV, 0.5 meV, 0.6 meV, 0.7 meV, 0.8 meV, 0.9 meV, 1 meV, 2 meV, 3 meV, 4 meV, 5 meV, 6 meV, 7 meV, 8 meV, 9 meV, or 10 meV.

In some cases, a trap depth of a coherent quantum matter-link may be about 50 meV to about 200 meV. In some cases, a trap depth of a coherent quantum matter-link may be about 50 meV to about 100 meV, about 50 me V to about 150 meV, about 50 meV to about 200 meV, about 100 meV to about 150 meV, about 100 meV to about 200 meV, or about 150 meV to about 200 meV. In some cases, a trap depth of a coherent quantum matter-link may be about 50 meV, about 100 meV, about 150 meV, or about 200 meV. In some cases, a trap depth of a coherent quantum matter-link may be at least about 50 meV, about 100 meV, about 150 meV, or about 200 meV.

In some cases, an ion height above surface electrode features may about 50 μm to about 350 μm. In some cases, an ion height above surface electrode features may be about 50 about 50 μm to about 100 μm, about 50 μm to about 150 μm, about 50 μm to about 200 μm, about 50 μm to about 250 μm, about 50 μm to about 300 μm, about 50 μm to about 350 μm, about 100 μm to about 150 μm, about 100 μm to about 200 μm, about 100 μm to about 250 μm, about 100 μm to about 300 μm, about 100 μm to about 350 μm, about 150 μm to about 200 μm, about 150 μm to about 250 μm, about 150 μm to about 300 μm, about 150 μm to about 350 μm, about 200 μm to about 250 μm, about 200 μm to about 300 μm, about 200 μm to about 350 μm, about 250 μm to about 300 μm, about 250 μm to about 350 μm, or about 300 μm to about 350 μm. In some cases, an ion height above surface electrode features may be about 50 μm, about 100 μm, about 150 μm, about 200 μm, about 250 μm, about 300 μm, or about 350 μm.

### Computer Systems

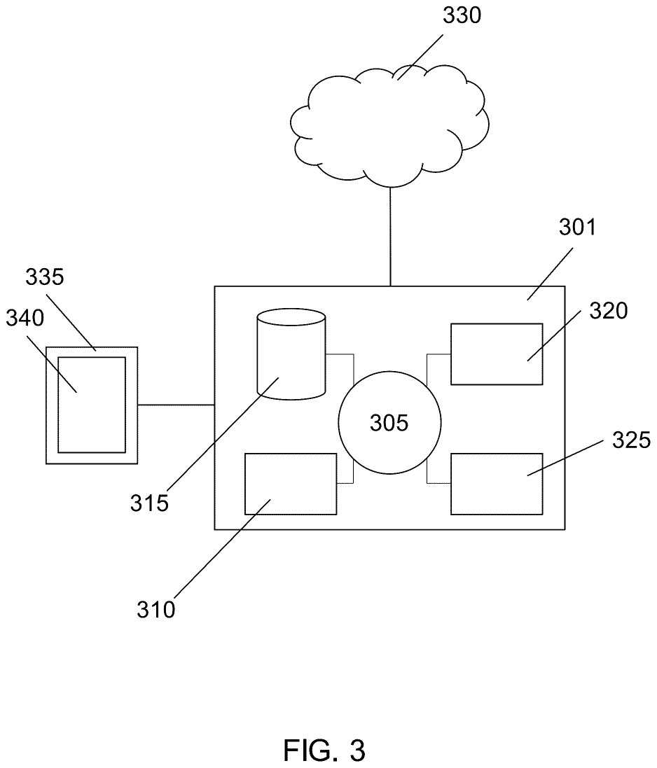

The present disclosure provides computer systems that are programmed to implement methods of the disclosure. FIG. 3 shows a computer system 301 that is programmed or otherwise configured to control or interface with trapped ion quantum computing systems disclosed herein. The computer system 301 can regulate various aspects of trapped ion quantum computers of the present disclosure, such as, for example, providing instructions to move an ion, providing instructions to perform an operation of a quantum computation, providing instructions to perform a gate operation, a one qubit operation, a two-qubit operation, a multi-qubit operation, a measurement, etc. The computer system 301 can be an electronic device of a user or a computer system that is remotely located with respect to the electronic device. The electronic device can be a mobile electronic device.

The computer system 301 includes a central processing unit (CPU, also “processor” and “computer processor” herein) 305, which can be a single core or multi core processor, or a plurality of processors for parallel processing. The computer system 301 also includes memory or memory location 310 (e.g., random-access memory, read-only memory, flash memory), electronic storage unit 315 (e.g., hard disk), communication interface 320 (e.g., network adapter) for communicating with one or more other systems, and peripheral devices 325, such as cache, other memory, data storage or electronic display adapters. The memory 310, storage unit 315, interface 320 and peripheral devices 325 are in communication with the CPU 305 through a communication bus (solid lines), such as a motherboard. The storage unit 315 can be a data storage unit (or data repository) for storing data. The computer system 301 can be operatively coupled to a computer network (“network”) 330 with the aid of the communication interface 320. The network 330 can be the Internet, an internet or extranet, or an intranet or extranet that is in communication with the Internet. The network 330 in some cases is a telecommunication or data network. The network 330 can include one or more computer servers, which can enable distributed computing, such as cloud computing. The network 330, in some cases with the aid of the computer system 301, can implement a peer-to-peer network, which may enable devices coupled to the computer system 301 to behave as a client or a server.

The CPU 305 can execute a sequence of machine-readable instructions, which can be embodied in a program or software. The instructions may be stored in a memory location, such as the memory 310. The instructions can be directed to the CPU 305, which can subsequently program or otherwise configure the CPU 305 to implement methods of the present disclosure. Examples of operations performed by the CPU 305 can include fetch, decode, execute, and writeback.

The CPU 305 can be part of a circuit, such as an integrated circuit. One or more other components of the system 301 can be included in the circuit. In some cases, the circuit is an application specific integrated circuit (ASIC).

The storage unit 315 can store files, such as drivers, libraries, and saved programs. The storage unit 315 can store user data, e.g., user preferences and user programs. The computer system 301 in some cases can include one or more additional data storage units that are external to the computer system 301, such as located on a remote server that is in communication with the computer system 301 through an intranet or the Internet.

The computer system 301 can communicate with one or more remote computer systems through the network 330. For instance, the computer system 301 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 301 via the network 330.

Methods as described herein can be implemented by way of machine (e.g., computer processor) executable code stored on an electronic storage location of the computer system 301, such as, for example, on the memory 310 or electronic storage unit 315. The machine executable or machine-readable code can be provided in the form of software. During use, the code can be executed by the processor 305. In some cases, the code can be retrieved from the storage unit 315 and stored on the memory 310 for ready access by the processor 305. In some situations, the electronic storage unit 315 can be precluded, and machine-executable instructions are stored on memory 310.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 301, can be embodied in programming. Various aspects of the technology may be thought of as “products” or “articles of manufacture” typically in the form of machine (or processor) executable code or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code or data. Many of these forms of computer readable media may be involved in carrying one or more sequences of one or more instructions to a processor for execution.

The computer system 301 can include or be in communication with an electronic display 335 that comprises a user interface (UI) 340. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 305.

While various embodiments of the invention have been shown and described herein, it will be obvious to those skilled in the art that such embodiments are provided by way of example only.

Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used in this specification and the appended claims, the singular forms “a,” “an,” and “the” include plural references unless the context clearly dictates otherwise. Any reference to “or” herein is intended to encompass “and/or” unless otherwise stated.

Certain inventive embodiments herein contemplate numerical ranges. When ranges are present, the ranges include the range endpoints. Additionally, every sub range and value within the range is present as if explicitly written out.

The term “about,” “substantially,” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

### EXAMPLES

### Example 1: Inter Module Transport via A Quantum Matter-Link

### Module Fabrication, Alignment, and Operation

Independent quantum computing modules were connected via the use of two linear surface-electrode Paul traps. Both ion-trap microchip modules were fabricated on a silicon substrate and feature electrode structures that extend to the edge of the inter-module gap, while the substrate recedes ˜75 μm away from the gap to facilitate module alignment. When the modules are aligned, this electrode configuration allows for the confining potential to extend over the inter-module gap, creating an electric field interface between the two modules.

FIG. 4A shows an image of two microfabricated ion-trap modules used to demonstrate inter-module transport. Each module is 17.5×13.5 mm² in size. A dashed box overlay signifies the area depicted in FIG. 4B. FIG. 4B is a schematic of 11 of the DC electrode pairs on the module “Alice” and 4 of the DC electrode pairs on the module “Bob.” Electrodes pairs 1-8 were used for ion transport over the 10(1) μm inter-module gap. The dimensions of the trap electrodes and inter-module gap are not drawn to scale. The DC electrodes are shown as an array of vertical rectangles (e.g., electrode pairs 1-8). Ions were loaded into the trap in the Loading Zone by the photoionization of neutral atoms (e.g., Yb) from a hot atomic beam, whose trajectory is restricted by a metal grating. This prevents contamination of the electrodes around Zones 1 and 2. In the Loading Zone, 369.5 nm, 935.1 nm, and 399.0 nm laser beams were overlapped. The 369.5 nm and 399.0 nm light were used for photoionization, and the 369.5 nm and 935.1 nm light were used for Doppler cooling. Once an ion was loaded, the 399.0 nm light was turned off. Thereafter both the ion and the remaining laser beams were translated to Zone 1. Detection of the ion occurred in Zone 1. Zone 1 and Zone 2 formed the start and end points of an inter-module coherent quantum matter-link.

One of the ion-trap modules (‘Alice,’ left of inter-module gap in FIG. 4B) was rigidly mounted to a vacuum chamber via a heat-sink circulating cryogenic helium gas such that the trap operated at 36-42 K. The second ion-trap module (‘Bob,’ right of inter-module gap in FIG. 4B) was cooled via a flexible copper braid forming a thermal link between the two modules. Bob was mounted to an in-vacuum three-axis piezo stage assembly (Physik Instrumente Ltd, P625.1 and P625.2). When considering many quantum computing modules tessellated into a large-scale architecture as presented in FIG. 2, small UHV-and cryogenic-compatible XYZ piezo actuators were installed beneath each module. These may be engineered from a combination of compact shear piezo actuators, providing the sufficient travel range to compensate for module drift that can arise from temperature changes while maintaining high module alignment accuracy.

The selection of piezo actuators was not constrained by the size of the module as only two modules required alignment in this example. Instead, the implemented piezo stage assembly was chosen for its fine 5-nm positioning accuracy and large travel range of 600 μm which provided additional experimental flexibility. To image the modules, a lens system with ×13 magnification was used in conjunction with a CMOS camera. The imaging system had a spatial resolution of 0.5 μm which led to an alignment error of 1 μm in the x-y plane. In the z-axis, the alignment was measured by scattering 369.5 nm laser light off each of the modules'surfaces. The beam was aligned parallel to the plane of the modules and lowered onto either side of the inter-module gap. The difference in the beam height at which scatter was maximized on each of the modules was used to determine the alignment. This procedure led to an alignment error in the z-axis of 3 μm. For comparison, 3-dimensional (3D) microfabricated ion traps constructed using wafer stacking techniques achieved an alignment accuracy between symmetric electrodes in the order of 10s of micrometers when aligned manually. Employing precision-machined self-aligning features directly integrated within the wafers, or semi-automatic bonding processes, have since reduced the alignment imprecision to ≤2.5 μm. Following alignment of Bob with respect to Alice, no measurable drift that would require periodic readjustment of the module position was observed.

For the results presented herein, the separation between Alice and Bob in each axis was measured to be Δx=10(1) μm, Δy=0(1) μm and Δz=0(3) μm. From previous simulations, a misalignment in all three axes by ≤10 μm may lead to an RF barrier ≤0.2 meV for a trap depth of ˜100 meV and an ion height of 100 μm. Both Alice and Bob were driven by independent RF circuits. These were calibrated to drive both modules at the same frequency, amplitude, and phase. RF voltages were applied at an amplitude V₀=101.75 V and frequency Ω_{RF}/2π=19.32 MHz, which from trap simulations using the Finite Element Method (FEM) were calculated to yield a trap depth of 53.9 meV. FEM simulations also indicated that changes in the height of the pseudopotential minimum across the inter-module gap that was limited to <100 nm around a mean ion height of 121.97 μm.

Results presented below used ¹⁷⁴Yb⁺ and ¹⁷¹Yb⁺. The qubit stored in the S_{1/2} hyperfine manifold of ¹⁷¹Yb⁺ were used to measure the effects of decoherence mechanisms on the matter-link, while ¹⁷⁴Yb⁺ was used to measure the infidelity associated with ion loss during transport due to its higher fluorescence rate.

To initialize the system, isotope selective loading occurred on Alice in the Loading Zone (FIG. 4B). Once loaded, the ions were shuttled from the Loading Zone to Zone 1 over a distance of 1840 μm, which was the starting point of all subsequent experiments. The axial trap frequency was υₐₓ=ωₐₓ/2π=141(1) kHz and the radial frequencies were υ_{rad}=ω_{rad}/2π=1.15(3) and 1.31(3) MHz.

### Inter-Module Ion Transport

Ion transport between modules was implemented in this example by varying the voltages applied to the 4 electrode pairs closest to the inter-module gap on both Alice and Bob (1-8 in FIG. 4B). Successive voltage updates sent to each electrode realized a translating potential well at the ion. Each ion transport from Zone 1→Zone 2, or Zone 2→Zone 1 constituted a single coherent quantum matter-link between modules. Zones 1 (2) were chosen as the start or end point of the link since the ion could be confined independently on Alice (Bob) without requiring potentials from the neighboring module. Zones 1 and 2 were separated by a distance of 684 μm. As an initial verification step, the success of the inter-module link was confirmed by imaging the scattered ion fluorescence in Zone 1 and in Zone 2, before and after ion transport. Thereafter, the lasers and detection optics were repositioned to detect ion fluorescence in Zone 1.

The infidelity associated with ion loss during inter-module transport was measured by transporting a single ¹⁷⁴Yb⁺ ion between Zone 1 and Zone 2. After each set of 2×10⁵ links the presence of the ion was verified by the detection of fluorescence using a photomultiplier tube (PMT). With a single link duration of 412.5 μs, at an equivalent link rate of 2424 s⁻¹, 15×10⁶ consecutive links were completed successfully. Further experiments placed an upper limit of 7×10⁻⁸ on the infidelity associated with ion loss during transport. The ion travelled 10.26 km at an average transport speed of 1.66 ms⁻¹. Throughout these transport measurements, the digital-to-analogue converters (DACs) were updated. This led to distortions in the transport waveforms, resulting from the low cut-off frequency of the DC filtering circuits. No difference in the ion lifetime for stationary and transported ions was identifiable, therefore the infidelity associated with ion loss during inter-module transport was not measurably affected by the distortions in the DC waveforms. The limit on the probability of successful transport is therefore attributed to laser instability and ion loss from collisions with background gas molecules.

The ion-transport rate was limited by hardware constraints. Faster transport times can be achieved by using DACs with a faster update rate, modifying the DC filter circuits to have a higher cut-off frequency or by pre-distorting the DC waveforms to compensate for the DC filter circuits.

### Preserving Qubit Coherence

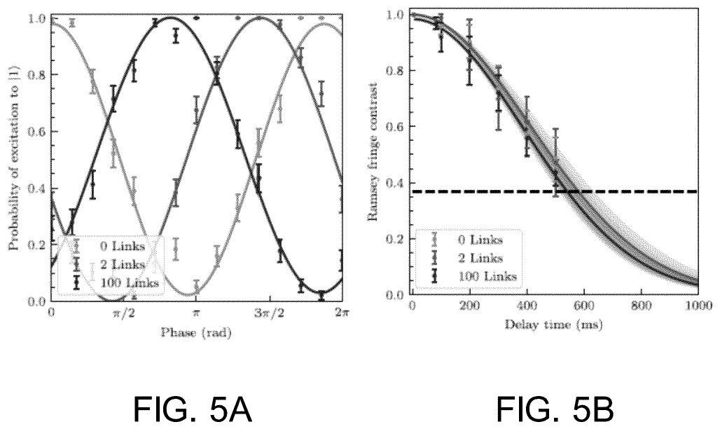

FIG. 5A is a plot of Ramsey fringes measured after 0, 2, and 100 links. The solid lines represent a sinusoidal fit to the data. For each dataset τ=100 ms, 100 averages were taken per data point. Error bars are standard deviations. The Ramsey fringe contrasts were found to be 0.96(2), 1.00(2) and 0.97(2) for 0, 2 and 100 links, respectively. FIG. 5B is a plot of the Ramsey fringe contrast as a function of time for 0, 2 and 100 links. The error bars represent the standard deviation in the measured contrast for a given time delay. The Gaussian fit to each dataset is given by the solid lines and the associated shaded areas represent the 1-sigma error in the fit. The dashed line indicates the 1/e decoherence threshold. The coherence times are 560(40) ms, 560(40) ms and 540(30) ms for 0, 2, and 100 links, respectively.

To show that the coherence of the qubit can be maintained throughout the matter-link, the effect of the inter-module transport on qubit states was investigated. Here the qubit was formed using two hyperfine levels of ¹⁷¹ Yb⁺ in the S_{1/2} manifold: |0>≡|F=0, mf=0>, |1>≡|F=1, mf=0>. The two states are separated by 12,642,812,118+311B² Hz where B is the magnetic field in Gauss. The ambient magnetic field at the qubit was 10.177(1) G as measured on the |F=0, mf=0> to |F=1, mf=−1> transition. The first order magnetic field insensitivity of the qubit (compared to the |F=1, mf=±1> states) increased its robustness against decoherence from ambient magnetic field fluctuations with the qubit transition frequency experiencing a magnetic field dependent linear slope of 6.2 kHz G⁻¹ at an ambient magnetic field of 10 G. The magnetic field fluctuations are therefore expected to result in a frequency shift of up to ±6 Hz, on timescales longer than the time taken for a single fringe measurement, as indicated by near unity fringe contrast in the measurements in FIG. 5A.

A Ramsey-type experiment is used to probe the coherence of the qubit by measuring the T₂* time. This experiment is performed by first optically pumping the ion into the |0> state and subsequently applying two π/2 Ramsey pulses, separated by a delay time τ. The pulses are applied using resonant microwave fields from an external microwave horn. The probability of the qubit being in |1> is then read out using a state-dependent fluorescence detection scheme. The experiment was then repeated with inter-module transport operations taking place during the delay time τ. FIG. 5A shows an example of a stationary Ramsey experiment in comparison to results using 2 and 100 links within the delay time. The Ramsey fringe contrasts measured were 0.96(2), 1.00(2) and 0.97(2) for 0, 2 and 100 links, respectively. The measured contrasts indicate that there is no measurable loss of qubit coherence during inter-module qubit transport for τ=100 ms.

FIG. 5A shows phase offsets of 1.8690(1) rad and 3.7988(1) rad for the 2 and 100 links respectively, relative to the stationary measurement. The experimental set-up does not include any magnetic field shielding or any active magnetic field stabilization. These phase offsets are attributed to miscalibrations in the energy level splitting frequency of the qubit, uncompensated magnetic field drifts and transport of the qubit through spatial magnetic field inhomogeneities. Once shielding or active magnetic field stabilization are installed, it is expected magnetic field drifts can be significantly or even arbitrarily reduced. Any phase accumulation resulting from ion transport across quasistatic magnetic field inhomogeneities can be calibrated and compensated for using an additional phase rotation after the transport operation.

Imperfections in the electrode-voltage signal chain, such as signal distortions from the filter circuits can lead to heating. Therefore, for the Ramsey sequence an inter-module transfer rate of 1250 s⁻¹ was used, and the number of links executed by the qubit within the delay time was restricted to 100. This ensured that the measurement statistics of the bright state remained unaffected by the reduction in fluorescence resulting from kinetic energy gain induced by ion-transport.

FIG. 5A demonstrates that, within the available measurement accuracy, qubit coherence was unaffected by inter-module transport at τ=100 ms. To investigate that qubit coherence was maintained throughout transport operations between quantum computing modules more generally, the Ramsey-type experiment shown in FIG. 5A was reproduced with longer delay times up to τ=500 ms. A Gaussian decay is then fitted to the fringe contrast to calculate a coherence time T₂*, where the Gaussian decay in fringe contrast was indicative of low frequency noise dominating the dephasing process. FIG. 5B shows the coherence measurements and the resultant fits. For the stationary case, τ₂*=560(40) ms, with 2 links, τ₂*=560(40) ms, and with 100 links, T 2* =540(30) ms. The main limiting factors of the coherence time are expected to be magnetic field fluctuations over the timescale of the experiment. Each of the 1-sigma errors of the measured coherence times overlap, demonstrating that a loss of coherence due to inter-module transport was not detectable within the uncertainty of the measurement.

FIG. 5A can be used to determine an upper bound for the loss of coherence of the qubit during transport. The lower bound of the fringe contrast for 100 links was determined to be 0.95.

This translates to an upper bound on the infidelity per link of 5×10⁻⁴. This confirms that the coherent quantum matter-link can be implemented to facilitate information transfer with a high quantum-state fidelity. The actual infidelity per link is expected to be orders of magnitude lower when using this method of estimation.

### Example 2: Surface-Electrode Ion-Trap Modules

Within each module, electrodes were produced using standard photolithography techniques. Dicing and isotropic silicon etching steps were subsequently used to create a precision align-able edge. This combination of processes ensured that the level of fabrication accuracy and surface quality was uniform across the quantum computing module. The roughness of the electrode edge sidewalls was measured to be submicron and did not hinder module-module alignment capabilities. Each module featured a pair of RF electrodes that were 270 μm wide, 1 μm thick and were separated by 90 μm, resulting in the RF pseudo-potential capable of radially confining ions at a height of 122 μm above the module's surface. Confinement in the axial direction was provided by outer segmented static voltage electrodes with width 220 μm, thickness 1 μm and separated by a gap of 10 μm. The RF and DC electrodes were linearly cut at the inter-module interface to connect quantum computing modules via ion transport operations. To prevent electrical discharges between electrodes, the separation between the RF electrodes and surrounding DC electrodes was 5 μm.

### Example 3: Ramsey Experimental Sequence

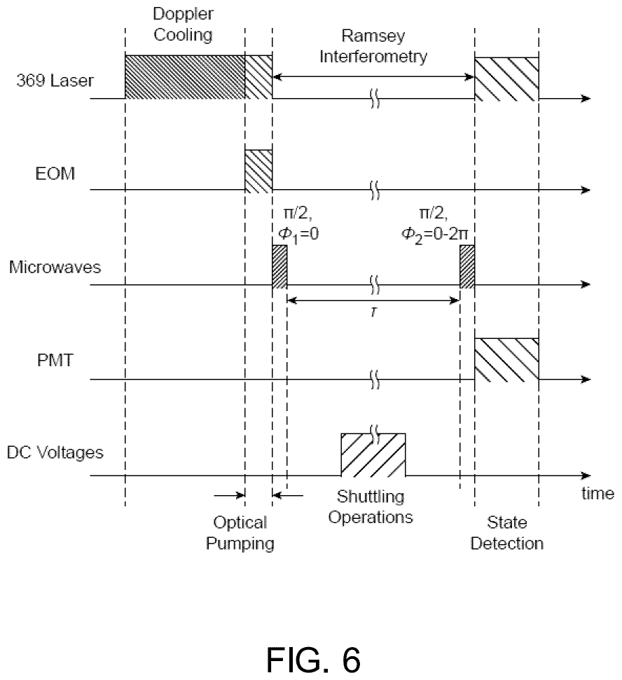

FIG. 6 shows a pulse sequence diagram for the Ramsey-type experiment. The relative times of the different processes are represented on the same time axis (not to scale). From the top down the axes are: the on/off times for the 369.5 nm Doppler cooling laser, the electro-optic modulator (EOM) for optical pumping, the microwaves resonant with the qubit transition, the PMT for detection and the DC electrodes for shuttling.

During the Ramsey-type experimental sequence shown in FIG. 6 the ion was initially Doppler cooled for up to 50 ms. Thereafter the ion was optically pumped into |0> over the course of 10 μs. The optical pumping is followed by an on-resonance microwave π/2 pulse with phase φ1=0 rad. The qubit was left to freely precess for a time delay τ, before a second π/2 pulse with phase offset of 0≤φ2≤2 π rad was applied. For each phase offset, the measurement was repeated 100 times. To measure the coherence time, the experimental sequence was repeated for τ={5, 100, 200, 300, 400, 500} ms for the stationary and 2 link data whereas the 100 link data spanned τ={83, 100, 200, 300, 400, 500} ms. When investigating the impact of the matter-link on the T₂* time, a variable number N={2, 100} of qubit transport operations can be undertaken within the delay time t, such that NTL<τ, where TL is the time taken for one link (800 μs).

### Example 4: Trap Rf Set-Up

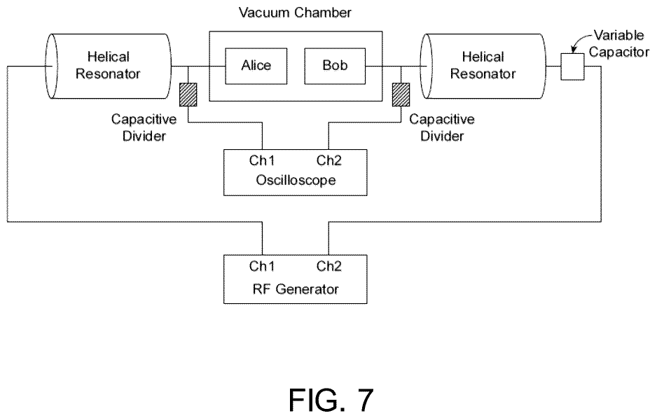

FIG. 7 is a diagram of the RF delivery system for the Alice and Bob trap modules (e.g., as shown in FIGS. 20A-B). Each of the modules used a separate RF source which was amplified and impedance matched to the ion traps using a helical resonator. A capacitive divider was used to measure the RF amplitude and phase applied to each trap on an oscilloscope. A variable capacitor was used to match the resonant frequency of the RF circuit for Bob with the RF circuit for Alice. Both modules (Alice and Bob) were driven using separate direct digital synthesizer (DDS) channels from an AD9910 Urukul card. Each DDS output was amplified and a helical resonator impedance matched the RF source to the ion trap module. While the helical resonators were constructed to be identical, a variable capacitor in the RF circuit of which Bob was a part allowed for the fine tuning of the resonant frequency of the Bob RF system to match that of the Alice RF system. A 1:54 capacitive divider was used after each helical resonator to measure the signal amplitude at which the module was driven on an oscilloscope. The RF output was then modified such that the amplitude at each module was the same within the 130 m V error of the oscilloscope. In addition, the capacitive dividers were also used to measure the relative phase of the RF signals of each of the modules and was corrected to match to within 35 μrad. The capacitive coupling between Alice and Bob was on the order of 1 fF such that parasitic cross-coupling was found to be negligible at the RF drive voltages used herein. The absence of significant capacitive cross-coupling was further confirmed by the lack of variation in both the S11 parameter of the helical resonator, and the resonant frequencies of the RF circuits, when the modules were aligned to one another.

### Example 5: Dc Coherent Quantum Matter-link Ion Transfer Protocol

A Sinara Kasli field-programmable gate array (FPGA) controller equipped with three AD5432 digital-to-analog converter (DAC) Zotino cards was used to control the DC waveforms applied to the ion-trap modules, for ion transport. The DAC cards update at a rate of 139 kHz per channel. Each DAC channel had an internal third-order Butterworth filter with 75 kHz cut-off frequency. In addition, a second set of second-order RC filters with a 47 kHz cut-off frequency was used prior to the vacuum chamber. Inside the vacuum chamber each DC channel was connected to a final first-order RC filter with a 257 kHz cut-off frequency.

The ion transfer waveforms were numerically determined from an FEM electrostatic simulation. The simulation included electrode potentials for both ion-trap modules. In order to calculate the potentials, a sequential least-squares programming (SLSQP) optimizer was used to minimize a cost function for a given ion position. The minimization problem was constructed from a cost function, which aimed to minimize the sum of the squares of the voltages across all electrodes. In addition, two constraint functions were also aimed to be minimized. These consisted of: (i) the electric field at the ion position, and (ii) the axial electric field curvature (and thus the axial secular frequency). Each constraint function was weighted with penalty factors p1 and p2 respectively such that the parameter that was to be minimized was normalized. This was due to several orders of magnitude in difference in the numerical values of each of these parameters. These penalty factors remained constant throughout the optimization.

Using this method, a set of voltage values was calculated. For the simulations used in this work, potentials were calculated in 2 μm steps between Zones 1 and 2. This provided trapping potentials that were linearly incremented along the ion transport path. The evolution of the voltage on each electrode was further post-processed using a second order Savitzky-Golay filter with a moving filter window of 25 voltage values. This post-processing removed numerical noise resulting from non-optimal solutions of the minimization problem, without distorting the waveform.

From the post-processed waveforms, the sets of voltage solutions were down-sampled to provide 12 μm incremented solutions for ion transport. This axial separation between steady state potential minima in the shuttling sequence was found to provide the best trade-off between shuttling rate and shuttling fidelity. Each set of voltages was applied at a constant time delay relative to the previous set of voltages. The combination of constant spacing and constant update rate of the voltage solutions led to a constant velocity of the trapped ion during transport.

### References Incorporated Herein

The following references are each incorporated by reference herein for all purposes:
Bruzewicz, C. D., Chiaverini, J., McConnell, R. & Sage, J. M., Trapped-ion quantum computing: Progress and challenges. Applied Physics Reviews 6(2019 ).
Wang, P. et al. Single ion qubit with estimated coherence time exceeding one hour. Nature Communications 12, 233 (2021).
Harty, T. P. et al. High-fidelity preparation, gates, memory, and readout of a trapped-ion quantum bit. Phys. Rev. Lett. 113, 220501 (2014).
Srinivas, R. et al. High-fidelity laser-free universal control of trapped ion qubits. Nature 597, 209-214 (2021).
Monz, T. et al. 14-Qubit entanglement: creation and coherence. Physical Review Letters 106, 130506 (2011).
Ladd, T. D. et al. Quantum computers. Nature 464, 45-53 (2010).
Popkin, G. Quest for qubits. Science 354, 1090-1093 (2016).
Clark, C. R. et al. High-fidelity bell-state preparation with 40ca+ optical qubits. Phys. Rev. Lett. 127, 130505 (2021).
Wright, K. et al. Benchmarking an 11-qubit quantum computer. Nature Communications 10, 1-6 (2019).
Pogorelov, I. et al. Compact ion-trap quantum computing demonstrator. PRX Quantum 2, 1 (2021).
Pino, J. M. et al. Demonstration of the trapped-ion quantum CCD computer architecture. Nature 592, 209-213 (2021).
Egan, L. et al. Fault-tolerant control of an error-corrected qubit. Nature 598, 281-286 (2021).
Brown, K. R., Kim, J. & Monroe, C. Co-designing a scalable quantum computer with trapped atomic ions. npj Quantum Information 2, 16034 (2016).
Wineland, D. J. et al. Experimental issues in coherent quantum-state manipulation of trapped atomic ions. Journal of Research of the National Institute of Standards and Technology 103, 259 (1998).
Kielpinski, D., Monroe, C. & Wineland, D. J. Architecture for a large-scale ion-trap quantum computer. Nature 417, 709-711 (2002).
Kaufmann, P., Gloger, T. F., Kaufmann, D., Johanning, M. & Wunderlich, C. High-fidelity preservation of quantum information during trapped-ion transport. Physical Review Letters 120, 010501 (2018).
Lekitsch, B. et al. Blueprint for a microwave trapped ion quantum computer. Science Advances 3, 1-12 (2017).
Ryan-Anderson, C. et al. Realization of real-time fault-tolerant quantum error correction. Physical Review X 11, 41058 (2021).
Hilder, J. et al. Fault-tolerant parity readout on a shuttling-based trapped-ion quantum computer. Physical Review X 12, 011032 (2022).
Bharti, K. et al. Noisy intermediate-scale quantum algorithms. Reviews of Modern Physics 94, 015004 (2022).
Cerezo, M. et al. Variational Quantum Algorithms. Nature Reviews Physics 3, 625-644 (2021).
Altman, E. et al. Quantum Simulators: Architectures and Opportunities. PRX Quantum 2, 017003 (2021).
Nigmatullin, R., Ballance, C. J., de Beaudrap, N. & Benjamin, S. C. Minimally complex ion traps as modules for quantum communication and computing. New Journal of Physics 18(2016 ).
Gidney, C. & Eker a, M. How to factor 2048 bit RSA integers in 8 hours using 20 million noisy qubits. Quantum 5, 1-31 (2021).
Webber, M., Elfving, V., Weidt, S. & Hensinger, W. K. The impact of hardware specifications on reach-ing quantum advantage in the fault tolerant regime. AVS Quantum Science 4, 013801 (2021).
Lee, J. et al. Even more efficient quantum computations of chemistry through tensor hypercontraction. PRX Quantum 2, 1 (2021).
Hucul, D. et al. Modular entanglement of atomic qubits using photons and phonons. Nature Physics 11, 37-42 (2015).
Stephenson, L. J. et al. High-rate, high-fidelity entanglement of qubits across an elementary quantum network. Phys. Rev. Lett. 124, 110501 (2020).
Monroe, C. & Kim, J. Scaling the ion trap quantum processor. Science 339, 1164-1169 (2013).
Monroe, C. et al. Large-scale modular quantum-computer architecture with atomic memory and photonic interconnects. Physical Review A 89, 022317 (2014).
Awschalom, D. et al. Development of quantum interconnects (QuICs) for next-generation information technologies. PRX Quantum 2, 1-21 (2021).
Ramette, J. et al. Any-To-Any Connected Cavity-Mediated Architecture for Quantum Computing with Trapped Ions or Rydberg Arrays. PRX Quantum 3, 010344 (2022).
Stopp, F., Lehec, H. & Schmidt-Kaler, F. A deterministic single ion fountain. Quantum Science and Technology 7, 034002 (2022).
Lebrun-Gallagher, F. R. et al. A scalable helium gas cooling system for trapped-ion applications. Quantum Science and Technology 7, 024002 (2022).
Pyka, K., Herschbach, N., Keller, J. & Mehlstaubler, T. E. A high-precision segmented Paul trap with minimized micromotion for an optical multiple-ion clock. Ap-plied Physics B: Lasers and Optics 114, 231-241 (2014).
Blakestad, R. B. et al. High-fidelity transport of trapped-ion qubits through an X-junction trap array. Physical Review Letters 102, 1-4 (2009).
Ragg, S., Decaroli, C., Lutz, T. & Home, J. P. Segmented ion-trap fabrication using high precision stacked wafers. Review of Scientific Instruments 90, 103203 (2019).
Decaroli, C. et al. Design, fabrication and characterization of a micro-fabricated stacked-wafer segmented ion trap with two X-junctions. Quantum Science and Tech-nology 6, 044001 (2021).
Auchter, S. et al. Industrially microfabricated ion trap with 1 eV trap depth. Quantum Science and Technology 7, 035015 (2022).
Ejtemaee, S., Thomas, R. & Haljan, P. Optimization of yb+ fluorescence and hyperfine-qubit detection. Physical Review A 82, 063419 (2010).
Olmschenk, S. et al. Manipulation and detection of a trapped Yb+ hyperfine qubit. Physical Review A 76, 052314 (2007).
Home, J. Entanglement of two trapped-ion spin qubits. Ph.D. thesis, University of Oxford (2006).
Bowler, R. et al. Coherent diabatic ion transport and separation in a multizone trap array. Physical review letters 109, 080502 (2012).
Walther, A. et al. Controlling fast transport of cold trapped ions. Physical review letters 109, 080501 (2012).
Gerritsma, R. et al. Precision measurement of the branching fractions of the 4 p 2p3/2 decay of ca ii. The European Physical Journal D 50, 13-19 (2008).
Kim, J. et al. 1100×1100 port MEMS-based optical cross-connect with 4-dB maximum loss. IEEE Photonics Technology Letters 15, 1537-1539 (2003).
Kasture, S. et al. Frequency conversion between UV and telecom wavelengths in a lithium niobate waveguide for quantum communication with Yb+ trapped ions. Journal of Optics 18(2016 ).
Wright, T. A. et al. Two-way photonic interface for linking the Sr+ transition at 422 nm to the telecommunication C band. Physical Review Applied 10, 1 (2018).
Siverns, J. D., Simkins, L. R., Weidt, S. & Hensinger, W. K. On the application of radio frequency voltages to ion traps via helical resonators. Applied Physics B 107, 921-934 (2012).
Kraft, D. A software package for sequential quadratic programming. Forschungsbericht-Deutsche Forschungs-und Versuchsanstalt fur Luft-und Raumfahrt (1988).
Savitzky, A. & Golay, M. J. Smoothing and differentiation of data by simplified least squares procedures. Analytical chemistry 36, 1627-1639 (1964).

1. A trapped-ion quantum computer, the trapped-ion quantum computer comprising:
a plurality of quantum computing modules; and
a coherent quantum matter-link between adjacent quantum computing modules, the coherent quantum matter-link comprising an infidelity per link of less than 5×10-4, wherein the infidelity per link characterizes a loss of coherence of an ion during transport between adjacent quantum computing modules.

2. The trapped-ion quantum computer of claim 1, wherein the coherent quantum matter-link comprises an infidelity associated with ion loss during transport of less than 7×10-8.

3. The trapped-ion quantum computer of claim 2, wherein the coherent quantum matter-link is characterized at a transfer rate of at least about 2424 s⁻¹ over a total distance of at least about 684 μm.

4. The trapped-ion quantum computer of claim 1, wherein each module of the plurality of quantum computing modules is fabricated on a substrate, wherein feature electrode structures on a module of the plurality of quantum computing modules extend at least partially to an edge of an inter-module gap, and wherein the substrate of the module recedes at most about 75 μm away from the inter-module gap.

5. The trapped-ion quantum computer of claim 4, wherein a confining potential is configured extend over the inter-module gap and create an electric field interface between the adjacent quantum computing modules.

6. The trapped-ion quantum computer of claim 4, wherein the feature electrode structures comprise a pair of RF electrodes configured to radially confine the ion.

7. The trapped-ion quantum computer of claim 6, wherein the pair of RF electrodes are configured to provide a trap depth of at least about 50 meV.

8. The trapped-ion quantum computer of claim 4, wherein the feature electrode structures comprise a plurality of DC electrode segments configured to axially confine the ion.

9. The trapped-ion quantum computer of claim 8, wherein the plurality of DC electrode segments is further configured to transport the ion along an axial direction.

10. The trapped-ion quantum computer of claim 9, wherein the plurality of DC electrode segments is configured to receive a voltage waveform, wherein the voltage waveform is configured to translate a potential well along the axial direction.

11. The trapped-ion quantum computer of claim 10, wherein a digital to analogue converter is configured to deliver the voltage waveform to a DC electrode of the plurality of DC electrode segments.

12. The trapped-ion quantum computer of claim 4, wherein the inter-module gap is at least about 10 μm.

13. The trapped-ion quantum computer of claim 4, wherein the feature electrode structures comprise a pair of RF electrodes situated between a pair of DC electrodes, and wherein the pair of RF electrodes and the pair or DC electrodes are disposed along an axis perpendicular to an ion transport direction.

14. The trapped-ion quantum computer of claim 4, wherein the feature electrode structures comprise a thickness of about 1 μm.

15. The trapped-ion quantum computer of claim 4, wherein the substrate comprises silicon.

16. The trapped-ion quantum computer of claim 4, wherein the feature electrode structures are fabricated by photolithography.

17. The trapped-ion quantum computer of claim 1, wherein a coherence time of the ion as least about 1,000 times greater than a duration of ion transport.

18. The trapped-ion quantum computer of claim 1, wherein a piezo actuator configured to align the adjacent quantum computing modules is installed beneath at least one of the adjacent quantum computing modules.

19. The trapped-ion quantum computer of claim 1, wherein an RF barrier along the coherent quantum matter-link is less than about 0.2 meV.

20. The trapped-ion quantum computer of claim 1, wherein the coherent quantum matter-link is characterized at a transfer rate of at least about 2424 s⁻¹ over a total distance of at least about 684 μm.
